(19) United States
(12) Patent Application Publication
(10) Pub. No.: US 2017/0155121 A1
(43) Pub. Date: Jun. 1, 2017

(54) NONAQUEOUS ELECTROLYTE SECONDARY BATTERY SEPARATOR

(71) Applicant: Sumitomo Chemical Company, Limited, Tokyo (JP)

(72) Inventor: Toshihiko OGATA, Osaka (JP)

(21) Appl. No.: 15/362,897

(22) Filed: Nov. 29, 2016

(30) Foreign Application Priority Data
Nov. 30, 2015 (JP) 2015-233940

(51) Int. Cl. H01M 2/16; H01M 2/14

(52) U.S. Cl. CPC H01M 2/1686; H01M 2/145; H01M 2/1653

(57) ABSTRACT

The present invention provides a nonaqueous electrolyte secondary battery separator which has an excellent rate characteristic and an excellent cycle characteristic and which is a porous film containing a polyolefin resin as a main component, the nonaqueous electrolyte secondary battery separator causing a diminution rate of diethyl carbonate dropped on the porous film to be 15 sec/mg to 21 sec/mg, and the nonaqueous electrolyte secondary battery separator causing a spot diameter of the diethyl carbonate 10 seconds after the diethyl carbonate was dropped on the porous film to be equal to or greater than 20 mm.

This Nonprovisional application claims priority under 35 U.S.C. §119 on Patent Application No. 2015-233940 filed in Japan on Nov. 30, 2015, the entire contents of which are hereby incorporated by reference.

### TECHNICAL FIELD

The present invention relates to (i) a separator, which is a porous film, for a nonaqueous electrolyte secondary battery (hereinafter referred to as “nonaqueous electrolyte secondary battery separator”) and (ii) a “laminated separator for a nonaqueous electrolyte secondary battery” (hereinafter referred to as “nonaqueous electrolyte secondary battery laminated separator”) prepared by laminating a porous layer on the porous film.

### BACKGROUND ART

Nonaqueous electrolyte secondary batteries, particularly lithium secondary batteries, have a high energy density and are thus in wide use as batteries for personal computers, mobile telephones, portable information terminals, and the like. Such nonaqueous electrolyte secondary batteries have recently been developed as on-vehicle batteries.

Nonaqueous electrolyte secondary batteries are known to have battery performance that, deteriorates as a result of a decrease in the amount of an electrolyte solution.

There has been proposed, as a nonaqueous electrolyte secondary battery capable of preventing battery performance from deteriorating, a nonaqueous electrolyte secondary battery including an electrolyte solution retaining layer which is directly sandwiched between an electrode (electrode active material layer) and a resin separator, the electrolyte solution retaining layer allowing a certain amount of electrolyte solution to be retained (Patent Literature 1).

### CITATION LIST

### Patent literature

[Patent Literature 1]

Japanese Patent, No. 5656093 (Issue date: Jan. 21, 2015)

### SUMMARY OF INVENTION

### Technical Problem

However, according to the nonaqueous electrolyte secondary battery, an electrolyte solution evaporates over time. This causes a reduction in the amount of electrolyte solution, and, as a result, may cause deterioration, of battery performance, particularly a discharge rate characteristic and a cycle characteristic. In addition, since the electrolyte solution retaining layer is provided between the separator and the electrode, the nonaqueous electrolyte secondary battery is large in size.

### Solution to Problem

In order to solve the problems, the inventors achieved the present invention by finding that a nonaqueous electrolyte secondary battery having excellent battery characteristics, particularly an excellent discharge rate characteristic and an excellent cycle characteristic, can be produced by controlling an electrolyte-solution-retaining property of a separator without providing an electrolyte solution retaining layer.

An embodiment of present invention can encompass (i) a nonaqueous electrolyte secondary battery separator, (ii) a nonaqueous electrolyte secondary battery laminated separator, (iii) a member for a nonaqueous electrolyte secondary battery (hereinafter referred to as “nonaqueous electrolyte secondary battery member”), (iv) a nonaqueous electrolyte secondary battery, (v) a nonaqueous electrolyte secondary battery separator production method, and (vi) a nonaqueous electrolyte secondary battery laminated separator production method, all of which will be described below.

The nonaqueous electrolyte secondary battery separator in accordance with an embodiment of the present invention, which is a porous film containing a polyolefin resin as a main component, the nonaqueous electrolyte secondary battery separator causing a diminution rate of diethyl carbonate dropped on the porous film to be 15 sec/mg to 21 sec/mg, and the nonaqueous electrolyte secondary battery separator causing a spot diameter of the diethyl carbonate 10 seconds after the diethyl carbonate was dropped on the porous film to be equal to or greater than 20 mm.

The nonaqueous electrolyte secondary battery laminated separator in accordance with an embodiment of the present invention includes: the nonaqueous electrolyte secondary battery separator in accordance with an embodiment of the present invention; and a porous layer laminated on at least one surface of the nonaqueous electrolyte secondary battery separator.

The nonaqueous electrolyte secondary battery separator in accordance with an embodiment of the present invention is preferably configured so that: the porous layer contains a polyvinylidene fluoride-based resin; or the porous layer contains electrically insulating fine particles.

The nonaqueous electrolyte secondary battery member in accordance with an embodiment of the present invention includes: a cathode; the nonaqueous electrolyte secondary battery separator in accordance with an embodiment of the present invention or the nonaqueous electrolyte secondary battery laminated separator in accordance with an embodiment of the present invention; and an anode, the cathode, the separator, and the anode being arranged in this order.

The nonaqueous electrolyte secondary battery in accordance with an embodiment of the present invention includes: the nonaqueous electrolyte secondary battery separator in accordance with an embodiment of the present invention or the nonaqueous electrolyte secondary battery laminated separator in accordance with an embodiment of the present invention.

A production method in accordance with an embodiment of the present invention is a method of producing the nonaqueous electrolyte secondary battery separator in accordance with an embodiment of the present invention or of producing the nonaqueous electrolyte secondary battery laminated separator in accordance with an embodiment of the present invention, the method including the steps of: extruding, in a sheet-like shape, a polyolefin resin composition from a T-die at a T-die extrusion temperature of 245° C. to 280° C., so as to obtain a sheet; and heat fixing the sheet at a heat fixing temperature of 100° C. to 125° C., so as to obtain a porous film containing a polyolefin resin as a main component.

### Advantageous Effects of Invention

A nonaqueous electrolyte secondary battery separator in accordance with an embodiment of the present invention and a nonaqueous electrolyte secondary battery laminated separator in accordance with an embodiment of the present invention can each provide an excellent discharge rate characteristic and an excellent cycle characteristic to a nonaqueous electrolyte secondary battery which includes the separator.

### DESCRIPTION OF EMBODIMENTS

The following description will discuss an embodiment of the present invention in detail. Note that any phrase “A to B” herein means “equal to or greater than A and equal to or less than B”.

### Embodiment 1: Nonaqueous Electrolyte Secondary Battery Separator, Embodiment 2: Nonaqueous Electrolyte Secondary Battery Laminated Separator

A nonaqueous electrolyte secondary battery separator in accordance with Embodiment 1 of the present invention, which is a porous film containing a polyolefin resin as a main component, the nonaqueous electrolyte secondary battery separator causing a diminution rate of diethyl carbonate dropped on the porous film to be 15 sec/mg to 21 sec/mg, and the nonaqueous electrolyte secondary battery separator causing a spot diameter of the diethyl carbonate 10 seconds after the diethyl carbonate was dropped on the porous film to be equal to or greater than 20 mm.

A nonaqueous electrolyte secondary battery laminated separator in accordance with Embodiment 2 of the present invention, includes: the nonaqueous electrolyte secondary battery separator in accordance with Embodiment 1 of the present invention (porous film); and a porous layer laminated on at least one surface of the nonaqueous electrolyte secondary battery separator.

<Porous Film>

The porous film in accordance with an embodiment of the present invention can be (i) the nonaqueous electrolyte secondary battery separator or (ii) a base material for the nonaqueous electrolyte secondary battery laminated separator described later. The porous film contains polyolefin as a main component. The porous film has a large number of pores therein, which pores are connected to one another, so that a gas, a liquid, or the like can pass through the porous film from one surface of the porous film to the other. The porous film can include a single layer or a plurality of layers.

The concept of “containing polyolefin resin as a main component” herein means that the polyolefin resin is contained in the porous film at a proportion of equal to or greater than 50% by volume, preferably equal to or greater than 90% by volume, and more preferably equal to or greater than 95% by volume of an entire portion of the porous film. The polyolefin resin more preferably contains a high molecular weight component having a weight-average molecular weight of 5×10⁵ to 15×10⁶. The polyolefin resin particularly preferably contains a high molecular weight component having a weight-average molecular weight of equal to or greater than 1,000,000 because such an amount of high molecular weight component allows for an increase in strength of (i) the nonaqueous electrolyte secondary battery separator which is the porous film and (ii) the nonaqueous electrolyte secondary battery laminated separator which serves as a laminated body including the porous film.

Examples of the polyolefin resin which is a main component of the porous film encompass, but are not particularly limited to, homopolymers (for example, polyethylene, polypropylene, and polybutene) and copolymers (for example, ethylene-propylene copolymer) produced through (co)polymerization of a monomer such as ethylene, propylene, 1-butene, 4-methyl-1-pentene, or 1-hexene. Among the above examples, polyethylene is preferable because it is able to prevent (shutdown) the flow of an excessively large current at a lower temperature. Examples of the polyethylene encompass a low-density polyethylene, a high-density polyethylene, a linear polyethylene (ethylene-α-olefin copolymer), and an ultra-high molecular weight polyethylene having a weight-average molecular weight of equal to or greater than 1,000,000. Among these examples, an ultra-high molecular weight polyethylene having a weight-average molecular weight of equal to or greater than 1,000,000 is preferable.

In a case where the porous film itself is to be the nonaqueous electrolyte secondary battery separator, a thickness of the porous film is preferably 4 μm to 40 μm, more preferably 5 μm to 30 μm, and still more preferably 6 μm to 15 μm. In a case where the porous film is used as a base material for the nonaqueous electrolyte secondary battery laminated separator and where the nonaqueous electrolyte secondary battery laminated separator (laminated body) is formed by laminating the porous layer on one surface or both surfaces of the porous film, the thickness of the porous film is preferably 4 μm to 40 μm, and more preferably 5 μm to 20 μm, although the thickness can be decided as appropriate in view of a thickness of the laminated body.

If the thickness of the porous film is below the above range, then a nonaqueous electrolyte secondary battery, which includes the nonaqueous electrolyte secondary battery separator using the porous film or the nonaqueous electrolyte secondary battery laminated separator using the porous film, makes it impossible to sufficiently prevent an internal short circuit of the battery, which internal short circuit is caused by breakage or the like of the battery. In addition, an amount of electrolyte solution to be retained by the porous film decreases. In contrast, if the thickness of the porous film is above the range, then there occurs an increase in resistance to permeation of lithium ions all over the nonaqueous electrolyte secondary battery separator using the porous film or all over the nonaqueous electrolyte secondary battery laminated, separator using the porous film. This causes a cathode of a nonaqueous electrolyte secondary battery, which includes the separator, to deteriorate in a case where a charge-discharge cycle is repeated. Consequently, a rate characteristic and/or a cycle characteristic deteriorate(s). In addition, since a distance between the cathode and an anode becomes longer, the nonaqueous electrolyte secondary battery becomes large in size.

A weight per unit area of the porous film only needs to be decided as appropriate in view of strength, thickness, weight, and handleability of (i) the nonaqueous electrolyte secondary battery separator serving as the porous film or (ii) the nonaqueous electrolyte secondary battery laminated separator including the porous film. Specifically, the weight per unit area of the porous film is preferably 4 g/m² to 20 g/m², and more preferably 5 g/m² to 12 g/m² on an ordinary basis so that the battery, which includes the nonaqueous electrolyte secondary battery separator or the nonaqueous electrolyte secondary battery laminated separator, can have high energy density per unit weight and high energy density per unit volume.

Air permeability of the porous film in terms of Gurley values is preferably 30 sec/100 mL to 500 sec/100 mL, and more preferably 50 sec/100 mL to 300 sec/100 mL. In a case where the air permeability of the porous film falls within these ranges, the nonaqueous electrolyte secondary battery separator serving as the porous film or the nonaqueous electrolyte secondary battery laminated separator including the porous film can have sufficient ion permeability.

Porosity of the porous film is preferably 20% by volume to 80% by volume, and more preferably 30% by volume to 75% by volume so that it is possible to increase the amount of electrolyte solution to be retained as well as to obtain a function of reliably preventing (shutting down) the flow of an excessively large current at a lower temperature.

If the porosity of the porous film is below 20% by volume, then a resistance of the porous film increases. If the porosity of the porous film is above 80% by volume, then mechanical strength of the porous film decreases.

A pore size of each of the pores of the porous film is preferably equal to or less than 0.3 μm, and more preferably equal to or less than 0.14 μm so that (i) the nonaqueous electrolyte secondary battery separator serving as the porous film or the nonaqueous electrolyte secondary battery laminated separator including the porous film can have sufficient ion permeability and (ii) it is possible to prevent particles from entering the cathode or the anode.

A diminution rate, by which diethyl carbonate (hereinafter referred to also as “DEC”) dropped on the porous film in accordance with an embodiment of the present invention diminishes, is 15 sec/mg to 21 sec/mg, preferably 16 sec/mg to 20 sec/mg, and more preferably 17 sec/mg to 19 sec/mg.

The fact that the diminution rate of diethyl carbonate dropped on the porous film is less than 15 sec/mg means that, in a case where a nonaqueous electrolyte secondary battery is constituted by using the porous film as the nonaqueous electrolyte secondary battery separator or as a member of the nonaqueous electrolyte secondary battery separator, liquid-retaining property of the porous film is poor. This causes the inside of the nonaqueous electrolyte secondary battery to dry out, and therefore causes deterioration the cycle characteristic of the nonaqueous electrolyte secondary battery. The fact that the diminution rate of diethyl carbonate on the porous film is greater than 21 sec/mg means that, in a case where a nonaqueous electrolyte secondary battery is constituted by using the porous film as the nonaqueous electrolyte secondary battery separator or as a member of the nonaqueous electrolyte secondary battery separator, a fluid (an electrolyte solution such as DEC or a gas generated from an electrolyte solution in the battery during battery charge/discharge) in holes (voids) in the porous film moves at slow moving speed. This causes the separator to have increased resistance to ion permeation (i.e. decreased ion permeability) as a result of (i) the battery drying out due to a lack of electrolyte solution which is supplied to electrodes during battery charge/discharge and (ii) the generated gas remaining in the voids. Consequently, the cycle characteristic of the nonaqueous electrolyte secondary battery deteriorates.

The “diminution rate of diethyl carbonate dropped on the porous film” herein refers to a speed at which the DEC that has been dropped on the porous film evaporates, and is measured by the following method under the following measurement conditions.
Measurement conditions: atmospheric pressure; room temperature (approximately 25° C.); humidity of 60% to 70%; and air velocity of equal to or less than 0.2 m/s;

### Measurement Method:

(i) A square piece having sides of 50 mm×50 mm each is cut out from the porous film, and is then placed on a polytetrafluoroethylene (PTFE) plate. Then, the PTFE plate, on which the porous film is placed, is placed on an analytical balance, and then a zero adjustment is carried out.
(ii) 20 μL of DEC is measured out with the use of a micropipette having a tip to which a pipette tip is attached.
(iii) 20 μL of the DEC measured out in the step (ii) is dropped (a) from a position which is 5 mm high above the porous film placed on the analytical balance which has been subjected to zero adjustment in the step (i) and (b) toward a center part of the porous film, and then a scale of the analytical balance, that is, a weight of the DEC is measured.
(iv) A length of time it takes for the weight of the DEC measured in the step (iii) to decrease from 15 mg to 5 mg is measured, and then the length of time thus measured is divided by an amount (10 mg) by which the weight of the DEG has changed, so that the “diminution rate by which the diethyl carbonate dropped on the porous film” (sec/mg) is calculated.

With the porous film in accordance with an embodiment of the present invention, a spot diameter of the diethyl carbonate 10 seconds after the diethyl carbonate was dropped on the porous film is equal to or greater than 20 mm, preferably equal to or greater than 21 mm, and more preferably equal to or greater than 22 mm. The spot diameter is also preferably equal to or less than 30 mm.

The fact that the spot diameter of the diethyl carbonate 10 seconds after the diethyl carbonate was dropped on the porous film is less than 20 mm means that the DEC thus dropped is absorbed into the voids inside the porous film at a slow speed, and therefore the porous film has low affinity with an electrolyte solution (such as DEC). Therefore, in a case where a nonaqueous electrolyte secondary battery is constituted by using the porous film as the nonaqueous electrolyte secondary battery separator or as a member of the nonaqueous electrolyte secondary battery separator, there is a reduction in a moving speed of an electrolyte solution such as DEC in the vicinity of an interface between the porous film and an electrode, particularly a reduction in a speed at which the DEC is absorbed from an electrode composite layer into the inside of the porous film during battery charge/discharge. Meanwhile, a decrease in permeation of the electrolyte solution into the inside of the porous film causes the amount of liquid retained in the porous film to decrease. This means that, in a case where battery charge/discharge is repeated, the electrolyte solution can easily be depleted locally (i) at the interface between the separator and the electrode and (ii) inside the porous film. As a result, resistance to ion permeation in the battery increases, and therefore the cycle characteristic of the nonaqueous electrolyte secondary battery deteriorates. Furthermore, the fact that the spot diameter of the diethyl carbonate 10 seconds after the diethyl carbonate was dropped on the porous film is greater than 30 mm means that, in a case where a nonaqueous electrolyte secondary battery is constituted by using the porous film as the nonaqueous electrolyte secondary battery separator or as a member of the nonaqueous electrolyte secondary battery separator, an affinity between the porous film and the electrolyte solution becomes excessively high, and that the electrolyte solution can be therefore retained in the porous film excessively easily. As a result, the electrolyte solution may be insufficiently supplied to an electrode during battery charge/discharge, and therefore the battery can easily dry out. This may cause the rate characteristic and the cycle characteristic of the nonaqueous electrolyte secondary battery to deteriorate.

The “spot diameter of the diethyl carbonate 10 seconds after the diethyl carbonate was dropped on the porous film” herein means a diameter of a dropped mark of the DEC remaining on the porous film after 10 seconds have passed since 20 μL of DEC was dropped on the porous film, and is measured by the following method under the following measurement conditions.
Measurement conditions: atmospheric pressure; room temperature (approximately 25° C.); humidity of 60% to 70%; and air velocity of equal to or less than 0.2 m/s;
Measurement method: Steps similar to the steps (i) through (iii) in the above method of measuring the “diminution rate by which the diethyl carbonate dropped on the porous film” are carried out. Then, DEC is dropped (a) from a position which is 5 mm high above the porous film and (b) toward a center part of the porous film. Then, after 10 seconds pass, a diameter of a dropped mark of the DEC remaining on the porous film is measured.

Note that in a case where, for example, there exists an adhering substance such as a resin powder and/or an inorganic matter on a surface of the porous film during measurement of the diminution rate of diethyl carbonate and the spot diameter, it is possible, as necessary, to (i) immerse, before the measurement, the porous film in an organic solvent such as DEC and/or water to wash and remove the adhering substance and the like and then (ii) carry out a pre treatment such as drying the solvent and the water.

The diminution rate of diethyl carbonate and the spot diameter can be controlled by, for example, setting a “T-die extrusion temperature” and a “heat fixing temperature after stretching” to respective certain ranges of temperatures in a porous film production method described later.

On the porous film, a publicly known porous layer including, for example, an adhesive layer, a heat-resistant layer, and/or a protection layer can be provided. A separator including a nonaqueous electrolyte secondary battery separator and a porous layer is herein referred to as a nonaqueous electrolyte secondary battery laminated separator (hereinafter referred to also as “laminated separator”). In a case where a porous layer is formed on a porous film, that is, in a case where a nonaqueous electrolyte secondary battery laminated separator is produced, it is preferable to carry out a hydrophilization treatment before the porous layer is formed, that is, before a coating solution described later is applied. In a case where the porous film is subjected to a hydrophilization treatment, applicability of the coating solution is enhanced. This allows a more uniform porous layer to be formed. A hydrophilization treatment is effective in a case where a solvent (dispersion medium) contained in a coating solution has a high water content. Specific examples of the hydrophilization treatment encompass publicly known treatments such as (i) a chemical treatment in which an acid, an alkali, or the like is used, (ii) a corona treatment, and (iii) a plasma treatment. Among these hydrophilization treatments, a corona treatment is more preferable because a corona treatment allows a porous film to be hydrophilized in a relatively short period of time and causes only a part in the vicinity of a surface of the porous film to be hydrophilized, so that the inside of the porous film remains unchanged in quality.

[Porous Layer]

The porous layer in accordance with an embodiment of the present invention can contain fine particles, and is ordinarily a resin layer containing a resin. The porous layer in accordance with an embodiment of the present invention is preferably a heat-resistant layer or an adhesive layer to be laminated on one surface or both surfaces of the porous film. The porous layer preferably contains a resin that (i) is insoluble in the electrolyte solution of the battery and that (ii) is electrochemically stable when the battery is in normal use. In a case where the porous layer is laminated on one surface of the porous film, the porous layer is preferably on that surface of the porous film which faces the cathode of a nonaqueous electrolyte secondary battery to be produced, more preferably on that surface of the porous film which comes into contact with the cathode.

Specific examples of the resin encompass polyolefins such as polyethylene, polypropylene, polybutene, and ethylene-propylene copolymer; fluorine-containing resins such as vinylidene fluoride-hexafluoropropylene copolymer, tetrafluoroethylene-hexafluoropropylene copolymer, tetrafluoroethylene-perfluoroalkyl vinyl ether copolymer, polyvinylidene fluoride (PVDF), and polytetrafluoroethylene; fluorine-containing rubbers such as vinylidene fluoride-hexafluoropropylene-tetrafluoroethylene copolymer and ethylene-tetrafluoroethylene copolymer; aromatic polyamides; fully aromatic polyamides (aramid resins); rubbers such as styrene-butadiene copolymer and a hydride thereof, methacrylic acid ester copolymer, acrylonitrile-acrylic acid ester copolymer, styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, polyetheramide, and polyester; and water-soluble polymers such as polyvinyl alcohol, polyethyleneglycol, cellulose ether, sodium alginate, polyacrylic acid, polyacrylamide, and polymethacrylic acid.

Specific examples of the aromatic polyamides encompass poly(paraphenylene terephthalamide), poly(methaphenylene isophthalamide), poly(parabenzamide), poly(methabenzamide), poly(4,4-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terepthalamide), paraphenylene terephthalamide/2,6-dichloroparaphenylene terephthalamide copolymer, and methaphenylene terephthalamide/2,6-dichloroparaphenylene terephthalamide copolymer. Among these, poly(paraphenylene terephthalamide) is preferable.

Among the above resins, a polyolefin, a fluorine-containing resin, an aromatic polyamide, and a water-soluble polymer are preferable. In particular, in the case where the porous layer is disposed so as to face the cathode, a fluorine-containing resin or a fluorine-containing rubber are more preferable, and a polyvinylidene fluoride-based resin (for example, a homopolymer of vinylidene fluoride (that is, polyvinylidene fluoride) or a copolymer of vinylidene fluoride and hexafluoropropylene, tetrafluoroethylene, trifluoro ethylene, trichloroethylene, or vinyl fluoride) are particularly preferable, to facilitate maintaining various performance capabilities of the nonaqueous electrolyte secondary battery such as the rate characteristic and resistance characteristic (solution resistance) even in a case where the battery suffers from acidic deterioration while being charged or discharged. A water-soluble polymer allows water to be used as a solvent to form the porous layer. Therefore, a water-soluble polymer is more preferable in view of a process and an environmental impact, cellulose ether and sodium alginate are still more preferable, and cellulose ether is particularly preferable.

Specific examples of the cellulose ether encompass carboxymethyl cellulose (CMC), hydroxyethyl cellulose (HEC), carboxy ethyl cellulose, methyl cellulose, ethyl cellulose, cyan ethyl cellulose, and oxyethyl cellulose. Among these, CMC and HEC, which less deteriorate after being used for a long time and have excellent chemical stability, are more preferable, and CMC is particularly preferable.

Fine particles herein refer to organic fine particles or inorganic line particles generally referred to as a filler. Therefore, the above resins each have a function as a binder resin for binding (i) fine particles together and (ii) fine particles and the porous film. The fine particles are preferably electrically insulating fine particles.

Specific examples of the organic fine particles contained in the porous layer in accordance with an embodiment of the present invention encompass (i) a homopolymer of a monomer such as styrene, vinyl ketone, acrylonitrile, methyl methacrylate, ethyl methacrylate, glycidyl methacrylate, glycidyl acrylate, or methyl acrylate, and (ii) a copolymer of two or more of such monomers; fluorine-containing resins such as polytetrafluoroethylene, ethylene tetrafluoride-propylene hexafluoride copolymer, tetrafluoroethylene-ethylene copolymer, and polyvinylidene fluoride; melamine resin; urea resin; polyethylene; polypropylene; and polyacrylic acid and polymethacrylic acid. These organic fine particles are electrically insulating fine particles.

Specific examples of the inorganic fine particles contained in the porous layer in accordance with an embodiment of the present invention encompass fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. These inorganic fine particles are electrically insulating fine particles. The porous layer may contain (i) only one kind of the filler or (ii) two or more kinds of the fillers in combination.

Among the above fillers, a filler made of inorganic matter is suitable. A filler made of an inorganic oxide such as silica, calcium oxide, magnesium oxide, titanium oxide, alumina, mica, zeolite, aluminum hydroxide, or boehmite is preferable. A filler made of at least one kind selected from the group consisting of silica, magnesium oxide, titanium oxide, aluminum hydroxide, boehmite, and alumina is more preferable. A filler made of alumina is particularly preferable. While alumina has many crystal forms such as α-alumina, β-alumina, γ-alumina, and θ-alumina, any of the crystal forms can be used suitably. Among the above crystal forms, α-alumina is the most preferable because it is particularly high in thermal stability and chemical stability.

The filler has a shape that varies depending on, for example, (i) the method of producing the organic matter or inorganic matter as a raw material and (ii) the condition under which the filler is dispersed when the coating solution for forming a porous layer is prepared. The filler may have any shape such as a spherical shape, an oblong shape, a rectangular shape, a gourd shape, or an indefinite, irregular shape.

In a case where the porous layer contains a filler, a filler content is preferably 1% by volume to 99% by volume, and more preferably 5% by volume to 95% by volume with respect to 100% by volume of the porous layer. In a case where the filler content falls within these ranges, it is less likely for a void, which is formed when fillers come into contact with each other, to be blocked by a resin or the like. This makes it possible to achieve sufficient ion permeability and a proper weight per unit area of the porous film.

The fine particles to be used can be a combination of two or more kinds which differ from each other in particle diameter and/or specific surface area.

A fine particle content of the porous layer is preferably 1% by volume to 99% by volume, and more preferably 5% by volume to 95% by volume with respect to 100% by volume of the porous layer. In a case where the fine particle content falls within these ranges, it is less likely for a void, which is formed when fine particles come into contact with each other, to be blocked by a resin or the like. This makes it possible to achieve sufficient ion permeability and a proper weight per unit area of the porous film.

A thickness of the porous layer in accordance with an embodiment of the present invention can be decided as appropriate in view of a thickness of the laminated body which is the nonaqueous electrolyte secondary battery laminated separator. Note, however, that in a case where the laminated body is formed by laminating the porous layer on one surface or both surfaces of the porous film serving as a base material, the thickness of the porous layer is preferably 0.5 μm to 1.5 μm (per surface of the porous film), and more preferably 2 μm to 10 μm (per surface of the porous film).

If the thickness of the porous layer is less than 1 μm, then the laminated body, which is used as a nonaqueous electrolyte secondary battery laminated separator, makes it impossible to sufficiently prevent an internal short circuit of the battery, which internal short circuit is caused by breakage or the like of the battery. In addition, an amount of electrolyte solution to be retained by the porous film decreases. In contrast, if a total thickness of both surfaces of the porous layer is above 30 μm, then the laminated body, which is used as a nonaqueous electrolyte secondary battery laminated separator, causes an increase in resistance to permeation of lithium ions all over the separator. This causes a cathode to deteriorate in a case where a charge-discharge cycle is repeated. Consequently, a rate characteristic and/or a cycle characteristic deteriorate(s). In addition, since a distance between the cathode and an anode becomes longer, the nonaqueous electrolyte secondary battery becomes large in size.

In a case where porous layers are laminated on respective both surfaces of the porous film, physical properties of the porous layer described below refer to at least physical properties of a porous layer which is laminated on a surface of the porous film, which surface faces a cathode included in a nonaqueous electrolyte secondary battery.

The weight per unit area of the porous layer (per surface of the porous film) can be decided as appropriate in view of strength, thickness, weight, and handleability of the laminated body. Note, however, that the weight per unit area of the porous layer is preferably 1 g/m² to 20 g/m², and more preferably 2 g/m² to 10 g/m² on an ordinary basis so that the battery can have high energy density per unit weight and high energy density per unit volume in a case where the laminated body is used as a nonaqueous electrolyte secondary battery laminated separator. If the weight per unit area of the porous layer is above these ranges, then the nonaqueous electrolyte secondary battery becomes heavy in weight in a case where the laminated body is used as a nonaqueous electrolyte secondary battery laminated separator.

A volume per square meter of a porous layer constituent component contained in the porous layer (per surface of the porous film) is preferably 0.5 cm³ to 20 cm³, more preferably 1 cm³ to 10 cm³, and still more preferably 2 cm³ to 7 cm³. In other words, a component volume per unit area of the porous layer (per surface of the porous film) is preferably 0.5 cm³/m² to 20 cm³/m², more preferably 1 cm³/m² to 10 cm³/m², and still more preferably 2 cm³/m² to 7 cm³/m². If the component volume per unit area of the porous layer is below 0.5 cm³/m², then the laminated body, which is used as a nonaqueous electrolyte secondary battery laminated separator, makes it impossible to sufficiently prevent an internal short circuit of the battery, which internal short circuit is caused by breakage or the like of the battery. If the component volume per unit area of the porous layer is above 20 cm³/m², then the laminated body, which is used as a nonaqueous electrolyte secondary battery laminated separator, causes an increase in resistance to permeation of lithium ions all over the separator. This causes a cathode to deteriorate in a case where a charge-discharge cycle is repeated. Consequently, a rate characteristic and/or a cycle characteristic deteriorate(s).

The component volume per unit area of the porous layer is calculated by the following method.
(1) A weight per unit area of each of components constituting the porous layer is calculated by multiplying a weight per unit area of the porous layer by a weight concentration of the each of the components (weight concentration in the porous layer).
(2) The weight per unit area of the each of the components thus obtained in the step (1) is divided by an absolute specific gravity of the each of the components. Then, a sum of numerical values thus obtained is designated as a component volume per unit area of the porous layer.

For the purpose of obtaining sufficient ion permeability, a porosity of the porous layer is preferably 20% by volume to 90% by volume, and more preferably 30% by volume to 80% by volume. In order for the porous layer and a nonaqueous electrolyte secondary battery laminated separator including the porous layer to obtain sufficient ion permeability, a pore size of each of the pores of the porous layer is preferably equal to or less than 3 μm, more preferably equal to or less than 1 μm, and still more preferably equal to or less than 0.5 μm.

[Laminated Body]

A laminated body, which is a nonaqueous electrolyte secondary battery laminated separator of the present invention, is configured by laminating the porous layer on one surface or both surfaces of the porous film.

The thickness of the laminated body in accordance with an embodiment of the present invention is preferably 5.5 μm to 45 μm, and more preferably 6 μm to 25 μm.

Air permeability of the laminated body in accordance with an embodiment of the present invention in terms of Gurley values is preferably 30 sec/100 mL to 1000 sec/100 mL, and more preferably 50 sec/100 mL to 800 sec/100 mL. In a case where the air permeability of the laminated body falls within the these ranges, the laminated body, which is used as a nonaqueous electrolyte secondary battery laminated separator, can have sufficient ion permeability. If the air permeability is above these ranges, then it means that the laminated body has a high porosity and that a laminated structure is therefore rough. This poses a risk that strength of the laminated body may decrease, so that shape stability particularly at a high temperature may be insufficient. In contrast, if the air permeability is below these ranges, then the laminated body, which is used as a nonaqueous electrolyte secondary battery laminated separator, may not have sufficient ion permeability. This may cause deterioration of the battery characteristic of the nonaqueous electrolyte secondary battery.

As necessary, the laminated body in accordance with an embodiment of the present invention can include, in addition to the porous film and the porous layer, a publicly known porous film(s) such as a heat-resistant layer, an adhesive layer, and/or a protection layer, provided that the object of an embodiment of the present invention is attained.

### Embodiment 3: Nonaqueous Electrolyte Secondary Battery Member, Embodiment 4: Nonaqueous Electrolyte Secondary Battery

A nonaqueous electrolyte secondary battery member in accordance with Embodiment 3 of the present invention includes: a cathode; the nonaqueous electrolyte secondary battery separator in accordance with Embodiment 1 of the present invention or the nonaqueous electrolyte secondary battery laminated separator in accordance with Embodiment 2 of the present invention; and an anode, the cathode, the separator, and the anode being arranged in this order. A nonaqueous electrolyte secondary battery in accordance with Embodiment 4 of the present invention includes the nonaqueous electrolyte secondary battery separator in accordance with Embodiment 1 of the present invention or the nonaqueous electrolyte secondary battery laminated separator in accordance with Embodiment 2 of the present invention. The nonaqueous electrolyte secondary battery in accordance with Embodiment 4 preferably includes the nonaqueous electrolyte secondary battery member in accordance with Embodiment 3 of the present invention. Note that the nonaqueous electrolyte secondary battery in accordance with Embodiment 4 of the present invention further includes a nonaqueous electrolyte solution.

[Nonaqueous Electrolyte Solution]

The nonaqueous electrolyte solution in accordance with an embodiment of the present invention is a nonaqueous electrolyte solution generally used for a nonaqueous electrolyte secondary battery. Examples of the nonaqueous electrolyte solution encompass, but are not particularly limited to, a nonaqueous electrolyte solution prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. The present embodiment may use (i) only one kind of the above lithium salts or (ii) two or more kinds of the above lithium salts in combination. The present embodiment preferably uses, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Specific examples of the organic solvent in the nonaqueous electrolyte solution in accordance with an embodiment of the present invention encompass carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into the organic solvent. The present embodiment may use (i) only one kind of the above organic solvents or (ii) two or more kinds of the above organic solvents in combination. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is preferably a mixed solvent of ethylene carbonate, dimethyl carbonate, and ethyl methyl carbonate because such a mixed solvent allows a wider operating temperature range, and is not easily decomposed even in a case where the present embodiment uses, as an anode active material, a graphite material such as natural graphite or artificial graphite.

[Cathode]

The cathode is ordinarily a sheet-shaped cathode including (i) a cathode mix containing a cathode active material, an electrically conductive material, and a binding agent and (ii) a cathode current collector supporting the cathode mix thereon.

The cathode active material is, for example, a material capable of being doped and dedoped with lithium ions. Specific examples of such a material encompass a lithium complex oxide containing at least one transition metal such as V, Mn, Fe, Co, or Ni. Among such lithium complex oxides, (i) a lithium complex oxide having an α-NaFeO₂ structure such as lithium nickelate and lithium cobaltate and (ii) a lithium complex oxide having a spinel structure such as lithium manganese spinel are preferable because such lithium complex oxides have a high average discharge potential. The lithium complex oxide containing the at least one transition metal may further contain any of various metallic elements, and is more preferably complex lithium nickelate.

Further, the complex lithium nickelate even more preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metallic element and the number of moles of Ni in the lithium nickelate. This is because such a complex lithium nickelate allows an excellent cycle characteristic in a case where it is used in a high-capacity battery. The active material particularly preferably contains Al or Mn, and contains Ni at a proportion of equal to or greater than 85%, further preferably equal to or greater than 90%. This is because a nonaqueous electrolyte secondary battery including a cathode containing such an active material has an excellent cycle characteristic in a case where the nonaqueous electrolyte secondary battery has a high capacity.

Examples of the electrically conductive material encompass carbonaceous materials such as natural graphite, artificial graphite, cokes, carbon black, pyrolytic carbons, carbon fiber, and a fired product of an organic polymer compound. It is possible to use (i) only one kind of the above electrically conductive materials or (ii) two or more kinds of the above electrically conductive materials in combination, for example, a mixture of artificial graphite and carbon black.

Examples of the binding agent encompass thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene-tetrafluoroethylene copolymer, a thermoplastic polyimide, polyethylene, and polypropylene, as well as acrylic resin and styrene-butadiene-rubber. The binding agent functions also as a thickening agent.

The cathode mix may be prepared by, for example, a method of applying pressure to the cathode active material, the electrically conductive material, and the binding agent on the cathode current collector or a method of using an appropriate organic solvent so that the cathode active material, the electrically conductive material, and the binding agent are in a paste form.

The cathode current collector is, for example, an electric conductor such as Al, Ni, and stainless steel, among which Al is preferable because Al is easily processed into a thin film and is inexpensive.

The sheet-shaped cathode may be produced, that is, the cathode mix may be supported by the cathode current collector, by, for example, a method of applying pressure to the cathode active material, the electrically conductive material, and the binding agent on the cathode current collector to form a cathode mix thereon or a method of (i) using an appropriate organic solvent so that the cathode active material, the electrically conductive material, and the binding agent are in a paste form to provide a cathode mix, (ii) applying the cathode mix to the cathode current collector, (iii) drying the applied cathode mix to prepare a sheet-shaped cathode mix, and (iv) applying pressure to the sheet-shaped cathode mix so that the sheet-shaped cathode mix is firmly fixed to the cathode current collector.

[Anode]

The anode is ordinarily a sheet-shaped anode including (i) an anode mix containing an anode active material and (ii) an anode current collector supporting the anode mix thereon. The sheet-shaped anode preferably contains the above-described electrically conductive material and binding agent.

The anode active material is, for example, (i) a material capable of being doped and dedoped with lithium ions, (ii) a lithium metal, or (iii) a lithium alloy. Specific examples of the material encompass carbonaceous materials such as natural graphite, artificial graphite, cokes, carbon black, pyrolytic carbons, carbon fiber, and a fired product of an organic polymer compound; chalcogen compounds such as an oxide and a sulfide that are doped and dedoped with lithium ions at an electric potential lower than that for the cathode; metals that can be alloyed with an alkali metal such as aluminum (Al), lead (Pb), tin (Sn), bismuth (Bi), and silicon (Si); cubic-crystal intermetallic compounds (for example, AlSb, Mg₂Si, and NiSi₂) of which an alkali metal is insertable into the lattice; and a lithium nitrogen compound such as Li₃₋ₓMₓN (where M is a transition metal). Among the above anode active materials, a carbonaceous material containing a graphite material such as natural graphite or artificial graphite as a main component is preferable because such a carbonaceous material has high electric potential flatness and low average discharge potential, and can thus be combined with a cathode to achieve a high energy density. The anode active material is also preferably a mixture of graphite and silicon with a Si content of equal to or greater than 5%, further preferably equal to or greater than 10%, with respect to carbon (C) which constitutes the graphite.

The anode mix may be prepared by, for example, a method of applying pressure to the anode active material on the anode current collector or a method of using an appropriate organic solvent so that the anode active material is in a paste form.

The anode current collector is, for example, Cu, Ni, or stainless steel, among which Cu is preferable because Cu is not easily alloyed with lithium in the case of a lithium ion secondary battery and is easily processed into a thin film.

The sheet-shaped anode may be produced, that is, the anode mix may be supported by the anode current collector, by, for example, a method of applying pressure to the anode active material on the anode current collector to form an anode mix thereon or a method of (i) using an appropriate organic solvent so that the anode active material is in a paste form to provide an anode mix, (ii) applying the anode mix to the anode current collector, (iii) drying the applied anode mix to prepare a sheet-shaped anode mix, and (iv) applying pressure to the sheet-shaped anode mix so that the sheet-shaped anode mix is firmly fixed to the anode current collector. The paste preferably contains the above-described electrically conductive material and binding agent.

The nonaqueous electrolyte secondary battery member in accordance with an embodiment of the present invention can be produced by, for example, arranging the cathode, the porous film or the laminated body, and the anode in this order. The nonaqueous electrolyte secondary battery in accordance with an embodiment of the present invention can be produced by (i) forming the nonaqueous electrolyte secondary battery member as described above, (ii) inserting the nonaqueous electrolyte secondary battery member into a container for use as a housing of the nonaqueous electrolyte secondary battery, (iii) filling the container with a nonaqueous electrolyte solution, and (iv) hermetically sealing the container under reduced pressure. The nonaqueous electrolyte secondary battery is not limited to any particular shape, and can have any shape such as the shape of a thin plate (sheet), a disk, a cylinder, or a prism such as a cuboid. A method of producing each of the nonaqueous electrolyte secondary battery member and the nonaqueous electrolyte secondary battery is not limited to any particular one, and can be any conventionally and publicly known method.

The nonaqueous electrolyte secondary battery member in accordance with an embodiment of the present invention and the nonaqueous electrolyte secondary battery in accordance with an embodiment of the present invention each include a porous film configured so that the above described “diminution rate by which the diethyl carbonate dropped on the porous film” and “spot diameter of the diethyl carbonate 10 seconds after the diethyl carbonate was dropped on the porous film” fall within respective certain ranges. Therefore, in a nonaqueous electrolyte secondary battery including the porous film, the following properties are each controlled to be in a fixed range: (i) a nonaqueous-electrolyte-solution-retaining property and (ii) a moving speed of a fluid in voids of the separator. Therefore, a nonaqueous electrolyte secondary battery including the nonaqueous electrolyte secondary battery member in accordance with an embodiment of the present invention and the nonaqueous electrolyte secondary battery in accordance with an embodiment of the present invention each have an excellent rate characteristic and an excellent cycle characteristic.

### Embodiment 5: Nonaqueous Electrolyte Secondary Battery Separator Production Method or Nonaqueous Electrolyte Secondary Battery Laminated Separator Production Method

A production method in accordance with Embodiment 5 of the present invention is a method of producing the nonaqueous electrolyte secondary battery separator in accordance with Embodiment 1 of the present invention or the nonaqueous electrolyte secondary battery laminated separator in accordance with Embodiment 2 of the present invention. The production method includes the steps of: (i) extruding, in a sheet-like shape, a polyolefin resin composition from a T-die at a T-die extrusion temperature of 245° C. to 280° C., so as to obtain a sheet and (ii) heat fixing the sheet at a heat fixing temperature of 100° C. to 125° C., so as to obtain a porous film containing a polyolefin resin as a main component.

[Porous Film Production Method]

A method of producing the porous film in accordance with an embodiment of the present invention, that is, a method of producing the nonaqueous electrolyte secondary battery separator in accordance with Embodiment 1 of the present invention, can be a method which (A) includes the steps of (i) extruding, in a sheet-like shape, a polyolefin resin composition from a T-die at a T-die extrusion temperature of 245° C. to 280° C., so as to obtain a sheet and (ii) heat fixing the sheet at a heat fixing temperature of 100° C. to 125° C., so as to obtain a porous film containing a polyolefin resin as a main component and (B) further includes an appropriate step that can be included in a general method of producing a porous film. Examples of the method encompass a method in which (i) a film is formed by adding a plasticizer to a resin such as polyolefin and then (ii) the plasticizer is removed with the use of an appropriate solvent.

Specifically, in a case where, for example, a porous film is produced with the use of a polyolefin resin including ultra-high molecular weight polyethylene and low molecular weight polyolefin having a weight-average molecular weight of equal to or less than 10,000, the porous film is, in view of production costs, preferably produced by the following method.
A method of obtaining a porous film, including the steps of:
(1) kneading 100 parts by weight of ultra-high molecular weight polyethylene, 5 parts by weight to 200 parts by weight of low molecular weight polyolefin having a weight-average molecular weight of equal to or less than 10,000, and 100 parts by weight to 400 parts by weight of a pore forming agent, so that a polyolefin resin composition is obtained;
(2) forming, into a sheet, the polyolefin resin composition with the use of a T-die at a T-die extrusion temperature of 245° C. to 280° C.;
(3) removing the pore forming agent from the sheet thus obtained in the step (2);
(4) stretching the sheet from which the pore forming agent has been removed in the step (3); and
(5) heat fixing the sheet, which has been thus stretched in the step (4), at a heat fixing temperature of 100° C. to 125° C. Alternatively, a method of obtaining a porous film, including the steps of:
(1) kneading 100 parts by weight of ultra-high molecular weight polyethylene, 5 parts by weight to 200 parts by weight of low molecular weight polyolefin having a weight-average molecular weight of equal to or less than 10,000, and 100 parts by weight to 400 parts by weight of a pore forming agent, so that a polyolefin resin composition is obtained;
(2) forming, into a sheet, the polyolefin resin composition with the use of a T-die at a T-die extrusion temperature of 245° C. to 280° C.;
(3′) stretching the sheet, thus obtained in the step (2);
(4′) removing the pore forming agent from the sheet thus stretched in the step (3′); and
(5′) heat fixing the sheet, which has been thus obtained in the step (4′), at a heat fixing temperature of 100° C. to 125° C.

Examples of the pore forming agent encompass an inorganic filler and a plasticizer.

Examples of the inorganic filler encompass, but are not particularly limited to, an inorganic filler that can be dissolved in a water-based solvent containing an acid, an inorganic filler that can be dissolved in a water-based solvent containing an alkali, and an inorganic filler that can be dissolved in a water-based solvent constituted mainly by water. Examples of the inorganic filler that can be dissolved in a water-based solvent containing an acid encompass calcium carbonate, a magnesium carbonate, a barium carbonate, a zinc oxide, a calcium oxide, an aluminum hydroxide, a magnesium hydroxide, a calcium hydroxide, and a calcium sulfate. Among these, a calcium carbonate is preferable because an inexpensive, fine powder of calcium carbonate can be easily obtained. Examples of the inorganic filler that can be dissolved in a water-based solvent containing an alkali encompass a silicic acid and a zinc oxide. Among these, a silicic acid is preferable because an inexpensive, fine powder of silicic acid can be easily allowed. Examples of the inorganic filler that can be dissolved in a water-based solvent constituted mainly by water encompass calcium chloride, sodium chloride, and magnesium sulfate.

Examples of the plasticizer encompass, but are not particularly limited to, a low molecular weight hydrocarbon such as liquid paraffin.

The T-die extrusion temperature in the step (2) is a temperature of the T-die when the polyolefin resin composition is extruded in a sheet-like shape, and is 245° C. to 280° C., and preferably 245° C. to 260° C.

In a case where the T-die extrusion temperature falls within these ranges, a resin to constitute the sheet to be obtained is oxidized to an appropriate extent, and is therefore increased in affinity with an electrolyte solution. This allows an electrolyte-solution-retaining property of a porous film, which is to be obtained, to increase to an appropriate extent.

The heat fixing temperature in each of the steps (5) and (5′) is 100° C. to 125° C., and preferably 100° C. to 120° C.

In a case where the heat fixing temperature fails within these ranges, a porous film to be obtained will have, inside thereof, holes (voids) whose pore size and channel (tortuosity) are controlled. This allows a speed at which the electrolyte solution inside the porous film evaporates (speed at which the electrolyte solution moves) to be controlled. As a result, the porous film to be obtained will have a liquid-retaining property and an in-void fluid moving speed, each of which is restricted to a specified range.

In a case where the T-die extrusion temperature and the heat fixing temperature fall within the above respective ranges, the porous film to be produced will be configured so that (i) an electrolyte-solution-retaining property is controlled to be in a preferable range and (ii) a fluid moving speed in the voids inside the porous film is controlled to be in a preferable range. This can allow for production of a porous film configured so that (i) a diminution rate of diethyl carbonate dropped on the porous film is 15 sec/mg to 21 sec/mg and (ii) a spot diameter of the diethyl carbonate 10 seconds after the diethyl carbonate was dropped on the porous film is equal to or greater than 20 mm.

[Porous Layer Production Method, Laminated Body Production Method]

Examples of a method of producing each of the porous layer in accordance with an embodiment of the present invention and the laminated body in accordance with an embodiment of the present invention encompass a method in which (i) a surface of the porous film is coated with a coating solution described later and then (ii) the coating solution is dried so as to precipitate the porous layer.

A coating solution used in the method of producing the porous layer in accordance with an embodiment of the present invention can ordinarily be prepared by (i) dissolving, in a solvent, a resin which will be contained in the porous layer in accordance with an embodiment of the present invention and (ii) dispersing, into the solvent, fine particles which will be contained in the porous layer in accordance with an embodiment of the present invention.

The solvent (disperse medium) can be any solvent which (i) does not adversely influence the porous film, (ii) allows the resin to be dissolved uniformly and stably, and (iii) allows the fine particles to be dispersed uniformly and stably. Specific examples of the solvent (disperse medium) encompass, but are not particularly limited to: water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide. The present embodiment may use only one kind of solvent (disperse medium) or two or more kinds of solvents in combination.

The coating solution may be formed by any method provided that the coating solution can meet conditions such as a resin solid content (resin concentration) and a fine particle amount necessary for obtaining a desired porous layer. Specific examples of a method of forming the coating solution encompass a mechanical stirring method, an ultrasonic dispersion method, a high-pressure dispersion method, a media dispersion method, and the like. Further, for example, the fine particles may be dispersed in the solvent (dispersion medium) by use of a conventionally and publicly known disperser such as a three-one motor, a homogenizer, a media disperser, or a pressure disperser. In addition, the coating solution can also be prepared simultaneously with wet grinding of fine particles in a case where a liquid in which a resin is dissolved or swelled, or a liquid in which a resin is emulsified is supplied to a wet grinding device during wet grinding carried out to obtain fine particles having a desired average particle size. That is, wet grinding of the fine particles and preparation of the coating solution may be simultaneously carried out in a single step. Further, the coating solution may contain, as a component other than the resin and the fine particles, an additive such as a disperser, a plasticizer, a surfactant, or a pH adjustor, provided that the additive does not impair the object of an embodiment of the present invention. Note that the additive may be contained in an amount that does not impair the object of an embodiment of the present invention.

The method of coating the porous film with the coating solution, that is, the method of forming a porous layer on a surface of a porous film that has been subjected to a hydrophilization treatment as necessary, is not limited to any particular one. In a case where porous layers are deposited on respective surfaces of the porous film, (i) it is possible to employ a sequential deposition method in which a porous layer is formed on one surface of the porous film and then another porous layer is formed on the other surface, or (ii) it is possible to employ a simultaneous deposition method in which porous layers are simultaneously formed on respective surfaces of the porous film. Examples of the method of forming the porous layer, that is, the method of producing the laminated body encompass: a method in which a surface of a porous film is directly coated with a coating solution, and then a solvent (dispersion medium) is removed; a method in which appropriate support is coated with a coating solution, a solvent (dispersion medium) is removed so as to form a porous layer, and then the porous layer and a porous film are bonded together by pressure, and then the support is peeled off; a method in which an appropriate support is coated with a coating solution, then a porous film is bonded to the coated surface by pressure, then the support is peeled off, and then the solvent (dispersion medium) is removed; and a method in which a porous film is soaked in a coating solution so as to carry out dip coating, and then a solvent (dispersion medium) is removed. A thickness of the porous layer can be controlled by adjusting a thickness of a coating film which is in a wet state (Wet) after coating, a weight ratio between the resin and the fine particles, a solid content concentration (i.e., a sum of a resin concentration and a fine particle concentration) of the coating solution, and the like. Note that examples of the support encompass a resin film, a metal belt, and a drum.

The method of coating the porous film or the support with a coating solution is not limited to any particular one, provided that the method can achieve a necessary weight per unit area and a necessary coating area. The method of applying the coating solution can be a conventionally and publicly known method. Specific examples of applying the coating solution encompass a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray coating method, and the like.

The solvent (disperse medium) is removed typically by a drying method. Examples of the drying method encompass natural drying, air-blowing drying, heat drying, and drying under reduced pressure. However, the solvent can be removed by any method that allows the solvent (disperse medium) to be removed sufficiently. The coating solution can be dried after the solvent (disperse medium) contained in the coating solution is replaced with another solvent. The solvent (disperse medium) can be replaced with another solvent for removal by, for example, a method of (i) preparing another solvent (hereinafter referred to as “solvent X”) that dissolves the solvent (disperse medium) contained in the coating solution and that does not dissolve the resin contained in the coating solution, (ii) immersing the porous film or support, to which the coating solution has been applied and on which a coating film has been formed, into the solvent X to replace the solvent (disperse medium) in the coating film on the porous film or support with the solvent X, and (iii) evaporating the solvent X. This method allows the solvent (disperse medium) to be removed efficiently from the coating solution. In a case where the coating film, formed on the porous film or support by applying the coating solution thereto, is heated when removing the solvent (disperse medium) or solvent X from the coating film, the coating film is desirably heated at a temperature that does not decrease the air permeability of the porous film, specifically within a range of 10° C. to 120° C., preferably within a range of 20° C. to 80° C., to prevent pores in the porous film from contracting to decrease the air permeability of the porous film.

It is preferable to remove the solvent (dispersion medium) by, in particular, a method in which a base material is coated with a coating solution and then the coating solution is dried so as to form a porous layer. With the configuration, it is possible to achieve a porous layer in which porosity varies by a smaller degree of variation and which hardly has a wrinkle.

The above drying can be carried out with the use of an ordinary drying device.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### EXAMPLES

The following description will discuss an embodiment of the present invention in more detail by Examples and Comparative Examples. Note, however, that an embodiment of the present invention is not limited to these Examples.

In Examples and Comparative Examples below, physical properties, such as a diminution rate of diethyl carbonate dropped on the porous film, a spot diameter of the diethyl carbonate 10 seconds after the diethyl carbonate was dropped on the porous film, and a cycle characteristic, were measured by the following method.

(Diminution Rate of Diethyl Carbonate Dropped on Porous Film)

The “diminution rate of diethyl carbonate dropped on the porous film (hereinafter referred to also as “diminution rate”)” of a nonaqueous electrolyte secondary battery separator produced in each of Examples and Comparative Examples was measured by the following method.

A square piece, which had sides of 50 mm×50 mm and which was to be measured, was cut out from a nonaqueous electrolyte secondary battery separator produced in each of Examples and Comparative Examples, and was then placed on a polytetrafluoroethylene (PTFE) plate under conditions of (i) atmospheric pressure, (ii) room temperature (approximately 25° C.), (iii) a humidity of 60% to 70%, and (iv) an air velocity of equal to or less than 0.2 m/s. Then, the polytetrafluoroethylene (PTFE) plate on which the square piece had been placed was placed on an analytical balance (manufactured by Shimadzu Corporation, model: AUW220), and was subjected to zero adjustment. Then, diethyl carbonate (DEC) was measured out with the use of a micropipette (manufactured by Eppendorf, model: Reference, designed for 20 μL) having a tip to which a pipette tip (manufactured by Eppendorf, product name: Standard, yellow tip designed for 0.5 μL to 20 μL) was attached. After zero adjustment was carried out, 20 μL of the DEC thus measured out was dropped from a position 5 mm high on a center part of the nonaqueous electrolyte secondary battery separator, and then an amount by which the weight changed was measured. Specifically, a length of time it took for the weight of the DEC to decrease from 15 mg to 5 mg (hereinafter referred to also as “evaporation time”) was measured. Then, the “evaporation time” thus measured was divided by the amount (10 mg) by which the weight of the DEC has changed, so as to obtain a value, which was then designated as a measured value of the “diminution rate”.

(Spot Diameter of Diethyl Carbonate 10 Seconds After Diethyl Carbonate was Dropped on Porous Film)

The “spot diameter of the diethyl carbonate 10 seconds after the diethyl carbonate was dropped on the porous film (hereinafter referred to also as “spot diameter”)” of the nonaqueous electrolyte secondary battery separator produced in each of Examples and Comparative Examples was measured by the following method.

Under measurement conditions and by a measurement method similar to those for the measurement of the “diminution rate”, 20 μL of DEC, which had been measured out, was dropped from a position 5 mm high on center part of the nonaqueous electrolyte secondary battery separator produced in each of Examples and Comparative Examples. After 10 seconds passed, a diameter of a dropped mark of the DEC remaining on the nonaqueous electrolyte secondary battery separator was measured. Then, a measured value was designated as a measured value of the “spot diameter”.

A “diminution rate” and a “spot diameter” of a nonaqueous electrolyte secondary battery separator produced in each of Examples and Comparative Examples were measured three times. Three measured values of the “diminution rate” were averaged so as to calculate the ultimate “diminution rate”. Three measured values of the “spot diameter” were averaged so as to calculate the ultimate “spot diameter”.

(Cycle Characteristic)

A new nonaqueous electrolyte secondary battery which had been produced in each of Examples and Comparative Examples and which had not been subjected to any cycle of charge/discharge was subjected to four cycles of initial charge/discharge. Each cycle of the initial charge/discharge was performed under conditions that the temperature was 25° C., the voltage range was 4.1 V to 2.7 V, and the current value was 0.2 C (1 C is defined as a value of a current at which a rated capacity based on a discharge capacity at 1 hour rate is discharged for 1 hour. The same is applied hereinafter).

Subsequently, an initial battery characteristic maintaining ratio at 55° C. was calculated according to the following Formula (1).

Initial battery characteristic maintaining ratio (%)=(discharge capacity at 20 C/discharge capacity at 0.2 C)×100 (1)

Subsequently, the nonaqueous electrolyte secondary battery was subjected to 100 cycles of charge/discharge, with each cycle being performed under conditions that (i) the temperature was 55° C. and (ii) constant currents were a charge current value of 1.0 C and a discharge current value of 10 C. Then, a battery characteristic maintaining ratio after 100 cycles was calculated according to the following Formula (2).

Battery characteristic maintaining ratio (%)=(discharge capacity at 20 C at 100th cycle/discharge capacity at 0.2 C at 100th cycle)×100 (2)

### Example 1

<Production of Nonaqueous Electrolyte Secondary Battery Separator>

Ultra-high molecular weight polyethylene powder (GUR4032, manufactured by Ticona Corporation) and polyethylene wax (FNP-0115, manufactured by Nippon Seiro Co., Ltd.) having a weight-average molecular weight of 1000 were mixed at a ratio of 71.5 weight %:28.5 weight %. Then, to 100 parts by weight of a mixture of the ultra-high molecular weight polyethylene and the polyethylene wax, the following were added: 0.4 parts by weight of antioxidant (Irg1010, manufactured by Ciba Specialty Chemicals Inc.), 0.1 parts by weight of antioxidant (P168, manufactured by Ciba Specialty Chemicals Inc.), and 1.3 parts by weight of sodium stearate. Then, calcium carbonate (manufactured by Maruo Calcium Co., Ltd.) having an average pore size of 0.1 μm was further added so as to account for 37% by volume of a total volume of the resultant mixture. Then, the resultant mixture while remaining a powder was mixed with the use of a Henschel mixer, so that a mixture 1 was obtained. Then, the mixture 1 was melted and kneaded with the use of a twin screw kneading extruder, so that a polyolefin resin composition 1 was obtained. Then, the polyolefin resin composition 1 was extruded in a sheet-like shape from a T-die which was set to 250° C. so as to obtain a sheet, and then the sheet was rolled with the use of a pair of rolls each having a surface temperature of 150° C., so that a rolled sheet 1 was prepared. Then, the rolled sheet 1 was immersed in a hydrochloric acid aqueous solution (containing 4 mol/L of hydrochloric acid and 0.5 weight % of a nonionic surfactant) so as to remove the calcium carbonate from the roiled sheet 1. Then, the resultant sheet was stretched with a stretch ratio of 7.0 times. Furthermore, the resultant sheet was heat fixed at 123° C. so that a porous film 1 was obtained. The porous film 1 thus obtained was designated as a nonaqueous electrolyte secondary battery separator 1.

<Preparation of Nonaqueous Electrolyte Secondary Battery >

(Preparation of Cathode)

A commercially available cathode, which was produced by coating an aluminum foil with a mixture of LiNi_{0.5}Mn_{0.3}Co_{0.2}O₂, an electrically conductive material, and PVDF (at a weight ratio of 92:5:3), was used. The aluminum foil was cut off to be a cathode so that a part in which no cathode active material layer was provided and which had a width of 13 mm was left around a part in which a cathode active material layer was provided and which had a size of 40 mm×35 mm. The cathode active material layer had a thickness of 58 μm and a density of 2.50 g/cm³.

(Preparation of Anode)

A commercially available anode, which was produced by coating a copper foil with a mixture of graphite, styrene-1,3-butadiene copolymer, and sodium carboxymethyl cellulose (at a weight ratio of 98:1:1), was used. The copper foil was cut off to be an anode so that a part in which no anode active material layer was provided and which had a width of 13 mm was left around a part in which an anode active material layer was provided and which had a size of 50 mm×40 mm. The anode active material layer had a thickness of 49 μm and a density of 1.40 g/cm³.

(Production of Nonaqueous Electrolyte Secondary Battery)

The cathode, the porous film 1 (electrolyte secondary battery separator 1), and the anode were laminated (arranged) in this order in a laminate pouch, so that a nonaqueous electrolyte secondary battery member 1 was obtained. In so doing, the cathode and the anode were arranged so that a main surface in the cathode active material layer of the cathode was entirely included in a range of a main surface in the anode active material layer of the anode (i.e. overlapped the main surface in the active material layer).

Subsequently, the nonaqueous electrolyte secondary battery member 1 was put in a bag which had been prepared in advance by laminating an aluminum layer and a heat seal layer, and 0.25 mL of a nonaqueous electrolyte solution was poured into the bag. The above nonaqueous electrolyte solution was prepared by dissolving LiPF₆ in a mixed solvent of ethylene carbonate, ethyl methyl carbonate, and diethyl carbonate at a ratio of 3:5:2 (volume ratio) so that the LiPF₆ would be contained at 1 mol/L. The bag was heat-sealed while a pressure inside the bag was reduced, so that a nonaqueous electrolyte secondary battery 1 was produced.

### Example 2

A porous film 2 was obtained as in Example 1 except that (i) the amount of ultra-high molecular weight polyethylene powder (GUR4032, manufactured by Ticona Corporation) was set to 70 weight %, (ii) the amount of polyethylene wax (FNP-0115, manufactured by Nippon Seiro Co., Ltd.) having a weight-average molecular weight of 1000 was set to 30 weight %, (iii) calcium carbonate (manufactured by Maruo Calcium Co., Ltd.) having an average pore size of 0.1 μm was added so as to account for 36% by volume of a total volume of the resultant mixture, (iv) the stretch ratio was set to 6.2 times, and (v) the heat fixing temperature was set to 120° C. The porous film 2 thus obtained was designated as a nonaqueous electrolyte secondary battery separator 2.

A nonaqueous electrolyte secondary battery 2 was prepared by a method similar to that used in Example 1 except that a porous film 2 instead of the porous film 1 was used.

### Example 3

A porous film 3 was obtained as in Example 2 except that the heat fixing temperature was set to 110° C. The porous film 3 thus obtained was designated as a nonaqueous electrolyte secondary battery separator 3.

A nonaqueous electrolyte secondary battery 3 was prepared by a method similar to that used in Example 1 except that a porous film 3 instead of the porous film 1 was used.

### Comparative Example 1

Ultra-high molecular weight polyethylene powder (GUR2024, manufactured by Ticona Corporation) and polyethylene wax (FNP-0115, manufactured by Nippon Seiro Co., Ltd.) having a weight-average molecular weight of 1000 were mixed at a ratio of 68 weight %:32 weight %. Then, to 100 parts by weight of a mixture of the ultra-high molecular weight polyethylene and the polyethylene wax, the following were added: 0.4 parts by weight of antioxidant (Irg1010, manufactured by Ciba Specialty Chemicals Inc.), 0.1 parts by weight of antioxidant (P168, manufactured by Ciba Specialty Chemicals Inc.), and 1.3 parts by weight of sodium stearate. Then, calcium carbonate (manufactured by Maruo Calcium Co., Ltd.) having an average pore size of 0.1 μm was further added so as to account for 38% by volume of a total volume of the resultant mixture. Then, the resultant mixture while remaining a powder was mixed with the use of a Henschel mixer, so that a mixture 4 was obtained. Then, the mixture 4 was melted and kneaded with the use of a twin screw kneading extruder, so that a polyolefin resin composition 4 was obtained. Then, the polyolefin resin composition 4 was extruded in a sheet-like shape from a T-die which was set to 240° C. so as to obtain a sheet, and then the sheet was rolled with the use of a pair of rolls each having a surface temperature of 150° C., so that a rolled sheet 4 was prepared. Then, the rolled sheet 4 was immersed in a hydrochloric acid aqueous solution (containing 4 mol/L of hydrochloric acid and 0.5 weight % of a nonionic surfactant) so as to remove the calcium carbonate from the rolled sheet 4. Then, the resultant sheet was stretched with a stretch ratio of 6.2 times. Furthermore, the resultant sheet was heat fixed at 126° C. so that a porous film 4 was obtained. The porous film 4 thus obtained was designated as a nonaqueous electrolyte secondary battery separator 4.

A nonaqueous electrolyte secondary battery 4 was prepared by a method similar to that used in Example 1 except that a porous film 4 instead of the porous film 1 was used.

### Comparative Example 2

A commercially available polyolefin separator was used as a porous film 5 (nonaqueous electrolyte secondary battery separator 5).

A nonaqueous electrolyte secondary battery 5 was prepared by a method similar to that used in Example 1 except that a porous film 5 instead of the porous film 1 was used.

The following Table 1 shows T-die extrusion temperatures and heat fixing temperatures used in Examples 1 through 3 and in Comparative Example 1.

TABLE 1

| | T-die extrusion | Heat fixing |
|---|---|---|
| | temperature [° C.] | temperature [° C.] |
| Example 1 | 250 | 123 |
| Example 2 | 250 | 120 |
| Examples 3 | 250 | 110 |
| Comparative Example 1 | 240 | 126 |

[Measurement Results]

The “evaporation time”, “diminution rate”, and “spot diameter” of each of nonaqueous electrolyte secondary battery separators 1 through 5 obtained in Examples 1 through 3 and Comparative Examples 1 and 2 were measured by the above described methods. Table 2 shows the results of the measurement.

The cycle characteristic of each of nonaqueous electrolyte secondary batteries 1 through 5 obtained in Examples 1 through 3 and Comparative Examples 1 and 2 was measured by the above described method. Table 2 shows the results of the measurement.

TABLE 2

| | | | | Initial | Battery |
|---|---|---|---|---|---|
| | | Dimi- | | battery | characteristic |
| | Evapo- | nution | Spot | characteristic | maintaining |
| | ration | rate | diameter | maintaining | ratio after |
| | time [s] | [s/mg.] | [mm] | ratio | 100 cycles |
| Example 1 | 178 | 17.8 | 21 | 78% | 55% |
| Example 2 | 151 | 15.1 | 23 | 77% | 52% |
| Example 3 | 204 | 20.4 | 21 | 84% | 49% |
| Comparative | 121 | 12.1 | 20 | 60% | 37% |
| Example 1 | | | | | |
| Comparative | 219 | 21.9 | 17 | 48% | 18% |
| Example 2 | | | | | |

### CONCLUSION

As shown in Table 2, it was confirmed that (i) the nonaqueous electrolyte secondary battery 4 (produced in Comparative Example 1), which included the nonaqueous electrolyte secondary battery separator 4 (produced in Comparative Example 1), resulted in an “evaporation time” of less than 150 seconds, that is, a “diminution rate” of less than 15 sec/mg and (ii) such a nonaqueous electrolyte secondary battery 4 had such a significantly low initial battery characteristic maintaining ratio as 60% and had such a significantly low battery characteristic maintaining ratio after 100 cycles as 37%. It was also confirmed that (i) the nonaqueous electrolyte secondary battery 5 (produced in Comparative Example 2), which included the nonaqueous electrolyte secondary battery separator 5 (produced in Comparative Example 2), resulted in an “evaporation time” of greater than 210 seconds, that is, a “diminution rate” of greater than 21 sec/mg and resulted in a “spot diameter” of less than 20 mm and (ii) such a nonaqueous electrolyte secondary battery separator 5 had such a significantly low initial battery characteristic maintaining ratio as 48% and had such a significantly low battery characteristic maintaining ratio after 100 cycles as 18%.

Meanwhile, it was confirmed that (i) the nonaqueous electrolyte secondary batteries 1 through 3 (produced in Examples 1 through 3, respectively), which respectively included the nonaqueous electrolyte secondary battery separators 1 through 3 (produced in Examples 1 through 3, respectively), resulted in “evaporation times” of 151 seconds to 204 seconds, that is, “diminution rates” of 15 sec/mg to 21 sec/mg and “spot diameters” of equal to or greater than 20 mm and (ii) such nonaqueous electrolyte secondary batteries 1 through 3 had initial battery characteristic maintaining ratios of equal to or greater than 75% and had battery characteristic maintaining ratios after 100 cycles of equal to or greater than 45%. This confirmed that the nonaqueous electrolyte secondary batteries 1 through 3 each had an excellent cycle characteristic.

### INDUSTRIAL APPLICABILITY

A nonaqueous electrolyte secondary battery separator in accordance with an embodiment of the present invention and a nonaqueous electrolyte secondary battery laminated separator in accordance with an embodiment of the present invention can each be suitable for production of a nonaqueous electrolyte secondary battery having an excellent discharge rate characteristic and an excellent cycle characteristic.

1. A nonaqueous electrolyte secondary battery separator which is a porous film containing a polyolefin resin at a proportion of equal to or greater than 50% by volume, the polyolefin resin containing a high molecular weight component having a weight-average molecular weight of 5×10⁵ to 15×10⁶,
the nonaqueous electrolyte secondary battery separator causing a diminution rate of diethyl carbonate dropped on the porous film to be 15 sec/mg to 21 sec/mg, and
the nonaqueous electrolyte secondary battery separator causing a spot diameter of the diethyl carbonate 10 seconds after the diethyl carbonate was dropped on the porous film to be equal to or greater than 20 mm.

2. A nonaqueous electrolyte secondary battery laminated separator comprising:
a nonaqueous electrolyte secondary battery separator recited in claim 1; and
a porous layer laminated on at least one surface of the nonaqueous electrolyte secondary battery separator.

3. The nonaqueous electrolyte secondary battery laminated separator as set forth in claim 2, wherein
the porous layer contains a polyvinylidene fluoride-based resin.

4. The nonaqueous electrolyte secondary battery laminated separator as set forth in claim 2, wherein
the porous layer contains electrically insulating fine particles.

5. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being arranged in this order.

6. A nonaqueous electrolyte secondary battery member comprising:
a cathode;
a nonaqueous electrolyte secondary battery laminated separator recited in claim 2; and
an anode,
the cathode, the nonaqueous electrolyte secondary battery laminated separator, and the anode being arranged in this order.

7. A nonaqueous electrolyte secondary battery comprising:
a nonaqueous electrolyte secondary battery separator recited in claim 1.

8. A nonaqueous electrolyte secondary battery comprising:
a nonaqueous electrolyte secondary battery laminated separator recited in claim 2.

9. A method of producing a nonaqueous electrolyte secondary battery separator recited in claim 1, the method comprising the steps of:
extruding, in a sheet-like shape, a polyolefin resin composition from a T-die at a T-die extrusion temperature of 245° C. to 280° C., so as to obtain a sheet, the polyolefin resin composition containing a high molecular weight component having a weight-average molecular weight of 5×10⁵ to 15×10⁶; and
heat fixing the sheet at a heat fixing temperature of 100° C. to 125° C., so as to obtain a porous film containing a polyolefin resin at a proportion of equal to or greater than 50% by volume.

10. A method of producing a nonaqueous electrolyte secondary battery laminated separator recited in claim 2, the method comprising the steps of:
extruding, in a sheet-like shape, a polyolefin resin composition from a T-die at a T-die extrusion temperature of 245° C. to 280° C., so as to obtain a sheet, the polyolefin resin composition containing a high molecular weight component having a weight-average molecular weight of 5×10⁵ to 15×10⁶; and
heat fixing the sheet at a heat fixing temperature of 100° C. to 125° C., so as to obtain a porous film containing a polyolefin resin at a proportion of equal to or greater than 50% by volume.
